(19) United States
(12) Patent Application Publication
(10) Pub. No.: US 2025/0146569 A1
(43) Pub. Date: May 8, 2025

(54) DRIVE SYSTEM FOR A MOTOR VEHICLE

(71) Applicant: Schaeffler Technologies AG & Co. KG, Herzogenaurach (DE)

(72) Inventor: Bernhard Walter, Oberkirch-Haslach (DE)

(73) Assignee: Schaeffler Technologies AG & Co. KG, Herzogenaurach (DE)

(21) Appl. No.: 18/837,620

(22) PCT Filed: Feb. 1, 2023
(86) PCT No.: PCT/DE2023/100080

§ 371 Date: Aug. 12, 2024

(30) Foreign Application Priority Data
Feb. 14, 2022 (DE) 10 2022 103 392.9
Jun. 9, 2022 (DE) 10 2022 114 475.5

(51) Int. Cl. F16H 57/04; B60K 1/02; B60K 17/354; B60K 17/356; F16H 57/02

(52) U.S. Cl. CPC F16H 57/0476; B60K 1/02; B60K 17/354; B60K 17/356; F16H 57/02; F16H 57/0436; F16H 57/045; F16H 2057/02034; F16H 2057/02052

(57) ABSTRACT

A drive system for a motor vehicle includes a first axle drive train which drives a first vehicle axle and is accommodated in a first drive train housing. A first electric machine and a first transmission arrangement form a first structural unit with the first electric machine. A second axle drive train drives a second vehicle axle and is accommodated in a second drive train housing and has a second electric machine and a second transmission arrangement forming a second structural unit with the second electric machine. The first electric machine and the second electric machine as well as the first transmission arrangement and the second transmission arrangement are substantially identically constructed.

### CROSS-REFERENCE TO RELATED APPLICATIONS

This application is the U.S. National Phase of PCT Appln. No. PCT/DE2023/100080 filed Feb. 1, 2023, which claims priority to DE 10 2022 103 392.9 filed Feb. 14, 2022 and DE 10 2022 114 475.5 filed Jun. 9, 2022, the entire disclosures of which are incorporated by reference herein.

### TECHNICAL FIELD

The present disclosure relates to a drive system for a motor vehicle, comprising a first axle drive train which drives a first vehicle axle and is accommodated in a first drive train housing and has a first electric machine and a first transmission arrangement forming a first structural unit with the first electric machine and a second axle drive train which drives a second vehicle axle and is accommodated in a second drive train housing and has a second electric machine and a second transmission arrangement forming a second structural unit with the second electric machine, wherein the first electric machine and the second electric machine as well as the first transmission arrangement and the second transmission arrangement are substantially identically constructed.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, 05/2011, pages 10-14 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable axle drive trains.

DE 10 2010 048 837 A1 discloses such a drive device having at least one electric motor and at least one planetary differential that can be driven by a rotor of the electric motor, wherein the planetary differential has at least one planetary carrier that is operatively connected to a rotor of the electric motor, first planetary gears and second planetary gears, which are rotatably mounted on the planetary carrier, and a first sun gear and a second sun gear, each of which is operatively connected to an output shaft of the planetary differential. The first planetary gears mesh with the first sun gear and each of the second planetary gears meshes with the second sun gear and with one of the first planetary gears. Furthermore, the sun gears are arranged coaxially with an axis of rotation of the rotor.

An axial flux machine is a dynamo-electric machine in which the magnetic flux between the rotor and stator runs parallel to the rotational axis of the rotor. Often, both the stator and the rotor are designed to be largely disc-shaped. Axial flux machines are particularly advantageous when the axially available installation space is limited in a given application. This is often the case, for example, with the electric drive systems for electric or hybrid vehicles described at the outset.

In addition to the shortened axial installation length, a further advantage of the axial flux machine is its comparatively high torque density. The reason for this is, compared to radial flux machines, the larger air gap area which is available for a given installation space. Furthermore, a lower iron volume is required compared to conventional machines, which has a positive effect on the efficiency of the machine.

Typically, an axial flux machine comprises at least one stator having windings for generating the axially aligned magnetic field. At least one rotor is equipped with permanent magnets, for example, the magnetic field of which interacts with the magnetic field of the stator windings in order to generate a drive torque over an air gap.

In the development of electric machines and transmissions intended for e-axles, there is a continuing need to increase their power densities, so that the cooling required for this, in particular of the electric machines and transmissions, is becoming increasingly important. Owing to the necessary cooling capacities, hydraulic fluids such as cooling oils have become established in most concepts for the removal of heat from the thermally loaded regions of an electric machine and/or transmission.

The transmissions commonly used in the designated e-axles are usually lubricated with a transmission oil, which is often also used as cooling oil for the electric machine. In order to reliably deliver the lubricant or cooling oil to the various lubrication or cooling points, it is known to form a corresponding hydraulic fluid circuit in the corresponding electric axles.

It is therefore quite common to form an oil sump within an electric axle for storing the amount of oil required for lubrication and cooling, from which the above-mentioned hydraulic fluid circuit is fed with oil.

It is becoming increasingly common to equip both vehicle axles with one electrically operable axle drive train each, in particular in the case of fully electrically operated drive concepts for motor vehicles. In order to save costs in this regard, there is an ongoing need to install as many identical parts as possible in the respective axle drive trains of the front and rear axles.

### SUMMARY

It is therefore the object of the disclosure to eliminate or at least mitigate the problems known from the prior art and to implement a drive system for a motor vehicle with two axle drive trains that can be manufactured inexpensively and to provide an effective and inexpensive cooling system.

This object is achieved by a drive system for a motor vehicle, comprising a first axle drive train which drives a first vehicle axle and is accommodated in a first drive train housing and has a first electric machine and a first transmission arrangement forming a first structural unit with the first electric machine and a second axle drive train which drives a second vehicle axle and is accommodated in a second drive train housing and has a second electric machine and a second transmission arrangement forming a second structural unit with the second electric machine, wherein the first electric machine and the second electric machine as well as the first transmission arrangement and the second transmission arrangement are substantially identically constructed, wherein the first axle drive train and the second axle drive train are arranged in the drive system in a manner rotated by an angle of 10-90° with respect to one another in relation to the axes of rotation of the respective electric machines, and the first drive train housing defines a first oil sump storing a first oil, and the second drive train housing defines a second oil sump storing a second oil, wherein the holding volume of the first oil sump corresponds to between 0.75-1.25 of the holding volume of the second oil sump.

This provides the advantage that a drive system with two axle drive trains can be provided which, in spite of the different installation positions of the axle drive trains, offers a high degree of efficiency due to the hydraulic cooling with the highest possible degree of part uniformity. The drive system according to the disclosure allows for different axle positions of the two axle drive trains in relation to one another to be covered by merely using different drive train housings. This means, for example, that a first axle drive train can be arranged in the front axle region in a manner optimized for installation space and a second axle drive train, which is rotated in relation to the first, can be arranged in the rear axle region in a manner optimized for installation space, although almost the same assemblies (electric machine, transmission arrangement) are used.

The individual elements of the claimed subject matter of the disclosure will be explained first, after which preferred embodiments of the subject matter of the disclosure will be described.

The drive system according to the disclosure comprises at least two electrically operable axle drive trains for driving two vehicle axles, wherein one axle drive train is associated with each vehicle axle. An electrically operable axle drive train comprises an electric machine and a transmission arrangement coupled to the electric machine. The transmission arrangement and the electric machine form a structural unit. This can be formed, for example, by means of a drive train housing, in which the transmission arrangement and the electric machine are accommodated together. The drive train housing can be of a single-part or multi-part design.

As such, it would, for example, also be possible for the electric machine to have a motor housing and/or the transmission to have a transmission housing, wherein the structural unit can then be effected by fixing the transmission in relation to the electric machine. In such a case, the motor housing and the transmission housing form part of the drive train housing.

The motor housing of one of the electric machines and/or a transmission housing of one of the transmission arrangements can also, in each case, be accommodated in a drive train housing. The drive train housing is preferably formed from a metallic material, particularly preferably from aluminum, gray cast iron or cast steel, in particular by means of a primary shaping process such as casting or die-casting. In principle, however, it would also be possible to form the drive train housing from a plastic material. The drive train housing may particularly preferably have a cup-like basic shape, such that the electric machine and the transmission arrangement can be inserted into the drive train housing via the open end face thereof.

The transmission housing is a housing for accommodating a transmission arrangement. It has the task of guiding existing shafts via the bearings and giving the wheels (possibly cam discs) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing should also dampen noise and vibrations and also be able to safely absorb lubricant. The transmission housing is preferably formed from a metallic material, particularly preferably from aluminum, gray cast iron or cast steel, in particular by means of a primary shaping process such as casting or die-casting. The transmission housing can be of a single-part or multi-part design.

The motor housing encloses the electric machine. A motor housing can also accommodate the control and power electronics. The motor housing can furthermore be part of a cooling system for the electric machine, and can be designed such that cooling fluid can be supplied to the electric machine via the motor housing and/or the heat can be dissipated to the outside via the housing surfaces. In addition, the motor housing protects the electric machine and any electronics that may be present from external influences.

A motor housing can be formed in particular from a metallic material. Advantageously, the motor housing can be formed from a metallic cast material, such as die-cast aluminum, die-cast magnesium, cast iron, or cast steel. The motor housing can be of a single-part or multi-part design.

An electric machine of an axle drive train of the drive system is used to convert electrical energy into mechanical energy and/or vice versa, and generally comprises a stationary part referred to as a stator, stand, or armature, and a part referred to as a rotor or runner, and arranged movably, in particular rotatably, relative to the stationary part.

An electric machine can be designed as a radial flux machine or an axial flux machine.

An electric machine of an axle drive train of the drive system according to the disclosure is preferably designed as an axial flux machine. The magnetic flux in an electric axial flux machine (AFM) is directed axially to a direction of rotation of the rotor of the axial flux machine in the air gap between the stator and the rotor. Different types of axial flux machines exist. One known type is what is termed an I arrangement, in which the rotor is arranged so as to be axially adjacent to a stator or between two stators. Another known type is what is termed an H arrangement, in which two rotors are arranged on opposite axial sides of a stator. The electric axial flux machine is preferably configured as an I-type.

In principle, it is also possible for a plurality of rotor-stator configurations to be arranged axially adjacent as an I-type and/or H-type. It would also be possible in this context to arrange both one or more I-type rotor-stator configurations and one or more H-type rotor-stator configurations adjacent to one another in the axial direction. In particular, it is also preferable that the rotor-stator configurations of the H-type and/or the I-type are each designed substantially identically, so that they can be assembled in a modular manner to form an overall configuration. Such rotor-stator configurations can in particular be arranged to be coaxial to one another and can be connected to a common rotor shaft or to a plurality of rotor shafts.

In particular, the electric machine is dimensioned such that vehicle speeds of more than 50 km/h, preferably more than 80 km/h and in particular more than 100 km/h can be achieved. The electric motor particularly preferably has an output of more than 30 kW, preferably more than 50 kW and in particular more than 70 kW. Furthermore, it is preferred that the electric machine provides speeds greater than 5,000 rpm, particularly preferably greater than 10,000 rpm, very particularly preferably greater than 12,500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

In particular, the transmission arrangement can be coupled to an associated electric machine of the axle drive train, which is designed to generate a drive torque for the motor vehicle. The drive torque is particularly preferably a main drive torque, such that the motor vehicle is driven exclusively by the drive torque. The transmission arrangement is preferably designed as a planetary transmission, very particularly preferably as a shiftable, in particular two-speed planetary transmission.

An electric machine of an axle drive train of the drive system can further have a control device. A control device, as may be used in the present disclosure, is used, in particular, for the open-and/or closed-loop electronic control of one or more technical systems of one of the electric machines.

A control device has, in particular, a wired or wireless signal input for receiving, in particular, electrical signals, such as sensor signals, for example. Furthermore, a control device also preferably has a wired or wireless signal output for the transmission of, in particular, electrical signals.

Open-loop control operations and/or closed-loop control operations can be carried out within the control device. It is very particularly preferred for the control device to comprise hardware that is designed to run software. The control device preferably comprises at least one electronic processor for executing program sequences defined in software.

The control device can furthermore have one or more electronic memories in which the data contained in the signals transmitted to the control device can be stored and read out again. Furthermore, the control device can have one or more electronic memories in which data can be stored in a modifiable and/or non-modifiable manner.

A control device can comprise a plurality of controllers which are arranged, in particular, spatially separate from one another in the motor vehicle. Controllers are also referred to as electronic control units (ECU) or electronic control modules (ECM) and preferably have electronic microcontrollers for carrying out computing operations for processing data, particularly preferably using software. The controllers can preferably be interconnected with one another such that a wired and/or wireless data exchange between controllers is made possible. In particular, it is also possible to interconnect the controllers with one another via bus systems present in the motor vehicle, such as a CAN bus or LIN bus for example.

Very particularly preferably, the control device has at least one processor and at least one memory, which in particular contains a computer program code, wherein the memory and the computer program code are configured to cause the control device to execute the computer program code with the processor.

The control device can particularly preferably comprise a power electronics unit for supplying current to a stator or rotor of an associated electric machine. A power electronics unit is preferably a combination of different components that provide an open-or closed-loop control of a current to the electric machine, preferably including the peripheral components required for this purpose, such as cooling elements or power supply units. In particular, the power electronics unit contains one or more power electronics components that are designed to provide an open-or closed-loop control of a current. These are particularly preferably one or more power switches, such as power transistors. The power electronics unit particularly preferably has more than two, particularly preferably three, phases or current paths which are separate from one another and each have at least one separate power electronics component. The power electronics unit is preferably designed to provide an open- or closed-loop control of a power per phase with a peak power, preferably continuous power, of at least 10 W, preferably at least 100 W, particularly preferably at least 1000 W.

An electric machine of an axle drive train of the drive system is preferably dimensioned such that vehicle speeds of more than 50 km/h, preferably more than 80 km/h and in particular more than 100 km/h can be achieved. The electric motor particularly preferably has an output of more than 30 kW, preferably more than 50 kW and in particular more than 70 kW. Furthermore, it is preferred that the electric machine provides speeds greater than 5,000 rpm, particularly preferably greater than 10,000 rpm, very particularly preferably greater than 12,500 rpm.

Advantageous embodiments of the disclosure are specified in the claims. The features listed individually in the claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, a first oil pump can be arranged in the first oil sump, which pumps the first oil from the first oil sump to the first electric machine and/or to the first transmission arrangement and/or a second oil pump can be arranged in the second oil sump, which pumps the second oil from the second oil sump to the second electric machine and/or to the second transmission arrangement.

The advantage of this embodiment is that an oil pump in an oil sump can be operated with particularly low noise levels, as it is acoustically insulated or silenced by the surrounding oil.

According to a further preferred further development of the disclosure, the first drive train housing can define a first transmission compartment for accommodating the first transmission arrangement, from which the first oil can be conveyed into the first oil sump via a first oil outlet opening, and/or the second drive train housing can define a second transmission compartment for accommodating the second transmission arrangement, from which the second oil can be conveyed into the second oil sump via a second oil outlet opening. This, firstly, allows the transmission compartment and the oil sump to be structurally separated. As a result, the transmission arrangement no longer reaches directly into the oil sump, which means that the transmission arrangement can, in particular, be operated with the lowest possible splash losses, which leads to significant increases in the efficiency of the corresponding transmission arrangement. For example, during operation of the transmission arrangement, merely a spur gear can scoop oil potentially present in the transmission compartment from the transmission compartment into the oil sump via the corresponding oil outlet opening. In the associated oil sump, the spatial separation also makes it easier to maintain an optimum oil filling level.

Furthermore, according to an equally advantageous embodiment of the disclosure, as already outlined above, the first transmission arrangement can, in particular, have a first gear wheel which is rotatable axially parallel to the axis of rotation of the first electric machine and by means of which the first oil located in the first transmission compartment can be conveyed out of the first transmission compartment through the first oil outlet opening into the first oil sump and/or the second transmission arrangement can have a second gear wheel which is rotatable axially parallel to the axis of rotation of the second electric machine and by means of which the second oil located in the second transmission compartment can be conveyed out of the second transmission compartment through the second oil outlet opening into the second oil sump.

According to a further particularly preferred embodiment of the disclosure, the first gear wheel can have a first axis of rotation which is arranged above the first oil outlet opening in the direction of gravity and/or the second gear wheel can have a second axis of rotation which is arranged above the second oil outlet opening in the direction of gravity. In particular, this ensures a good scooping effect with respect to the scooping of oil from the transmission chamber into the corresponding oil sump.

Furthermore, the disclosure can also be further developed such that the first gear wheel is surrounded in the circumferential direction and in sections by a channel-like circular-ring-section-shaped first housing section of the first drive train housing and/or the second gear wheel is surrounded in the circumferential direction and in sections by a channel-like circular-ring-section-shaped second housing section of the second drive train housing.

The advantage of this embodiment is that, on the one hand, it is possible to further reduce splash losses and, on the other hand, the scooping effect of the corresponding gear wheel can be further improved.

In a likewise preferred embodiment of the disclosure, the first drive train housing can be of a multi-part design and/or the second drive train housing can be of a multi-part design. This improves the adaptability of the drive train housing to the installation space situation and at the same time further increases part uniformity by using housing elements made up of identical parts.

It can also be advantageous to further develop the disclosure such that the first drive train housing comprises a first motor housing for accommodating the first electric machine and a first transmission housing for accommodating the first transmission arrangement, wherein the first oil sump is formed in and/or on the first transmission housing and/or the second drive train housing comprises a second motor housing for accommodating the second electric machine and a second transmission housing for accommodating the second transmission arrangement, wherein the second oil sump is formed in and/or on the second transmission housing, which can also further increase part uniformity of the housing components, as required component variants are limited to the transmission housings.

According to a further preferred embodiment of the subject matter of the disclosure, the first electric machine can have a first control unit for supplying current to the first electric machine and the second electric machine can have a second control unit for supplying current to the second electric machine, wherein the first control unit and the second control unit are substantially identically constructed, which can also contribute to an increased part uniformity of the drive system.

Finally, the disclosure can also be advantageously designed such that the first axle drive train comprises two first electric machines arranged coaxially to one another, axially directly adjacent to one another, each in an axial flux configuration and/or the second axle drive train comprises two second electric machines arranged coaxially to one another, axially directly adjacent to one another, each in an axial flux configuration. The advantage of this is, in particular, that an axially very compact axle drive train can be provided, via which the two vehicle wheels of a vehicle axle can be driven by an associated electric machine in each case, which improves the driving dynamics and stability of the drive system.

### BRIEF DESCRIPTION OF THE DRAWINGS

The disclosure is explained in more detail below with reference to drawings without limiting the general concept of the disclosure.

In the drawings:

FIG. 1 shows a drive system of a motor vehicle with two axle drive trains in a schematic block diagram,

FIG. 2 shows the drive system known from FIG. 2 in a perspective view of the two axle drive trains,

FIG. 3 shows a schematic cross-sectional view of the first axle drive train,

FIG. 4 shows a schematic cross-sectional view of the second axle drive train.

### DETAILED DESCRIPTION

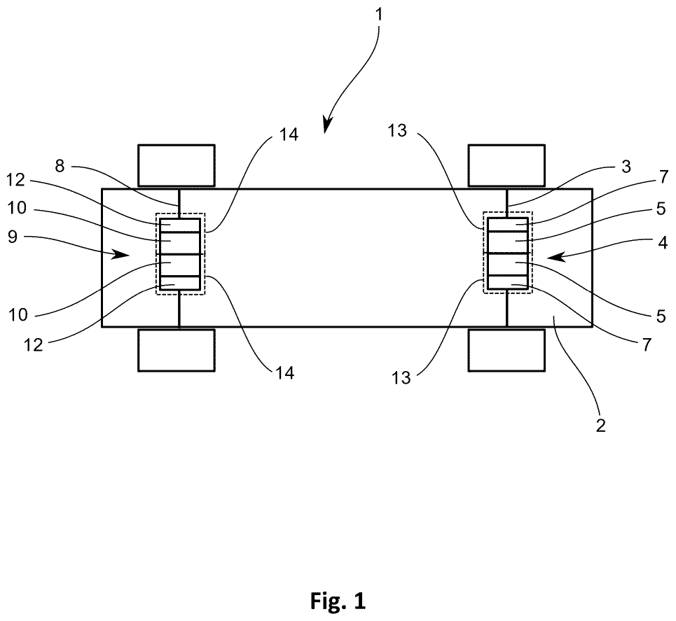

FIG. 1 shows a drive system 1 for a motor vehicle 2, comprising a first axle drive train 4 which drives a first vehicle axle 3 and is accommodated in a first drive train housing 13 and has a first electric machine 5 and a first transmission arrangement 7 forming a first structural unit 6 with the first electric machine 5.

The drive system 1 further comprises a second axle drive train 9 which drives a second vehicle axle 8 and is accommodated in a second drive train housing 14 and has a second electric machine 10 and a second transmission arrangement 12 forming a second structural unit 11 with the second electric machine 10.

The first electric machine 5 and the second electric machine 10 as well as the first transmission arrangement 7 and the second transmission arrangement 12 are substantially identically constructed.

In the embodiment shown in FIG. 1, the first axle drive train 4 has two first electric machines 5 arranged coaxially to one another, axially directly adjacent to one another, each in an axial flux configuration, and the second axle drive train 9 analogously also has two second electric machines 10 arranged coaxially to one another, axially directly adjacent to one another, each in an axial flux configuration. As a result, each vehicle wheel of the motor vehicle 2 can be driven by an electric machine 5,10.

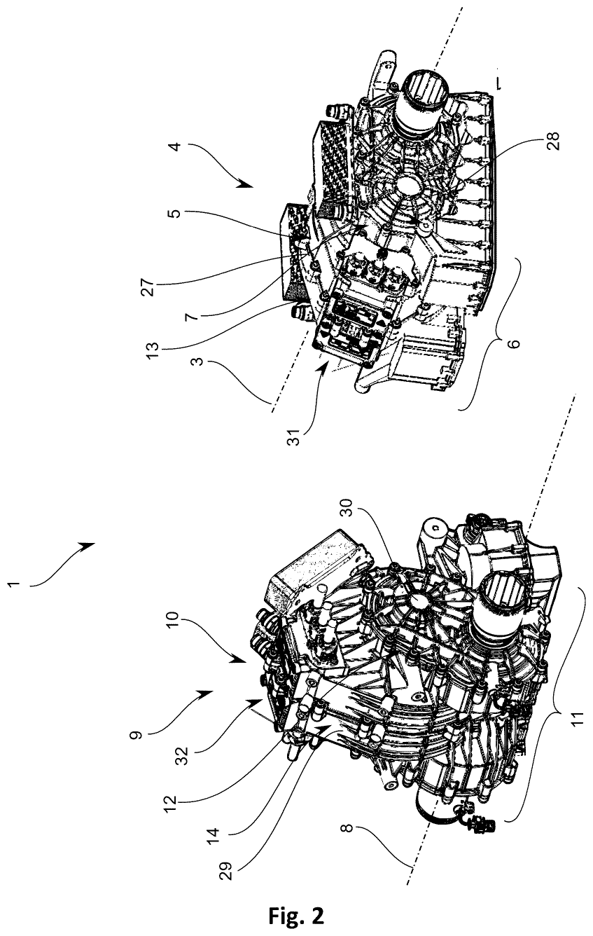

Due to the different installation space situation on the two vehicle axles 3,8, the first axle drive train 4 and the second axle drive train 9 are arranged in the drive system 1 in a manner rotated by an angle of 10-90° with respect to one another in relation to the axes of rotation of the respective electric machines 5,10, which can be seen particularly clearly in FIG. 2.

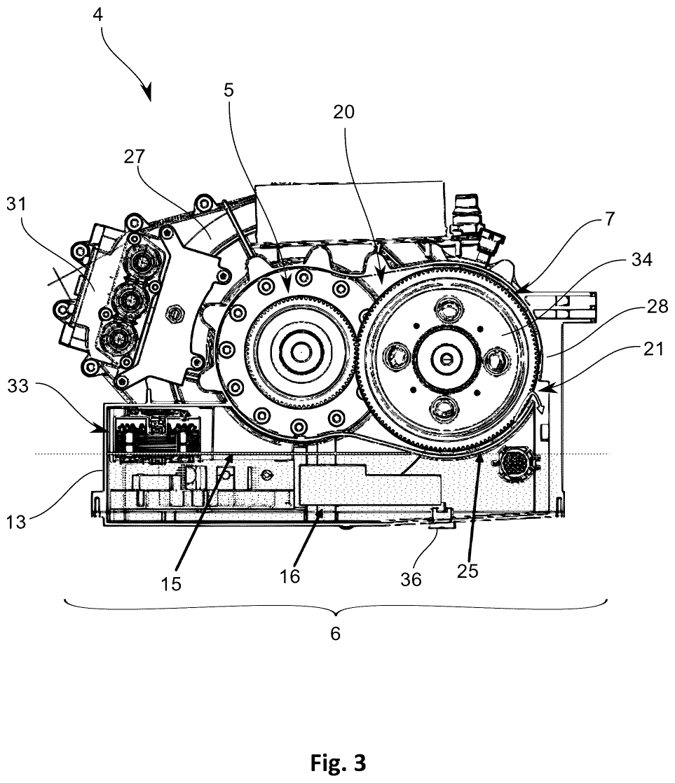

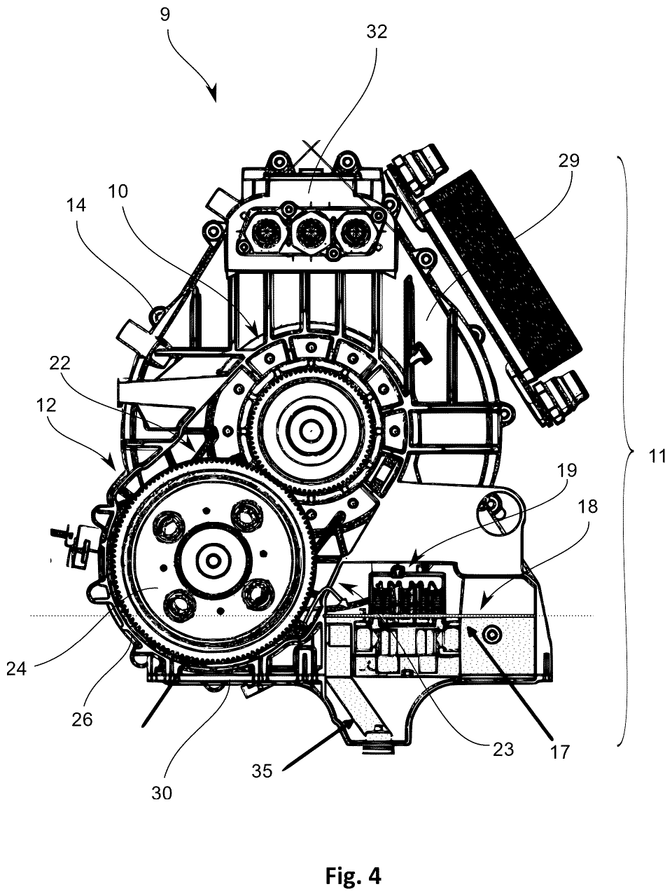

In this regard, the first drive train housing 13 defines a first oil sump 16 storing a first oil 15, while the second drive train housing 14 provides a second oil sump 18 storing a second oil 17, wherein the holding volume of the first oil sump 16 corresponds to between 0.75-1.25 of the holding volume of the second oil sump 18. The oils 16,17 and their filling levels are indicated by a dotted representation in FIGS. 3-4. A first oil discharge opening 36 and a second oil discharge opening 35 are provided, in each case, on the bottom side of the oil sumps 16,18 in the direction of gravity.

FIGS. 3-4 also show that a first oil pump 33 is arranged in the first oil sump 16, which pumps the first oil 15 from the first oil sump 16 to the first electric machine 5 and to the first transmission arrangement 7 and a second oil pump 19 is arranged in the second oil sump 18, which pumps the second oil 17 from the second oil sump 18 to the second electric machine 10 and to the second transmission arrangement 12.

The first drive train housing 13 defines a first transmission compartment 20 for accommodating the first transmission arrangement 7, from which the first oil 15 can be conveyed into the first oil sump 16 via a first oil outlet opening 21, which is shown in FIG. 3. Similarly, FIG. 4 shows that the second drive train housing 14 defines a second transmission compartment 22 for accommodating the second transmission arrangement 12, from which the second oil 17 can be conveyed into the second oil sump 18 via a second oil outlet opening 23.

Furthermore, the first transmission arrangement 7 has a first gear wheel 34 which is rotatable axially parallel to the axis of rotation of the first electric machine 5 and by means of which the first oil 15 located in the first transmission compartment 20 can be conveyed out of the first transmission compartment 20 through the first oil outlet opening 21 into the first oil sump 16. The second transmission arrangement 12 also has a second gear wheel 24 which is rotatable axially parallel to the axis of rotation of the second electric machine 10 and by means of which the second oil 17 located in the second transmission compartment 22 can be conveyed out of the second transmission compartment 22 through the second oil outlet opening 23 into the second oil sump 18.

Furthermore, the first gear wheel 34 has a first axis of rotation which is arranged above the first oil outlet opening 21 in the direction of gravity. The second gear wheel 24 also has a second axis of rotation which is arranged above the second oil outlet opening 23 in the direction of gravity, which can again be easily recognized from the synopsis of FIGS. 3-4.

FIG. 3 further shows that the first gear wheel 34 is surrounded in the circumferential direction and in sections by a channel-like circular-ring-section-shaped first housing section 25 of the first drive train housing 13, while, as shown in FIG. 4, the second gear wheel 24 is also surrounded in the circumferential direction and in sections by a channel-like circular-ring-section-shaped second housing section 26 of the second drive train housing 14.

The exemplary embodiments in FIGS. 3-4 thus also clearly show how the installation space separation between the oil sumps 16,18 and the transmission compartments 20,22 can be designed in terms of construction.

Also shown in FIG. 3 is that the first drive train housing 13 comprises a first motor housing 27 for accommodating the first electric machine 5 and a first transmission housing 28 for accommodating the first transmission arrangement 7, wherein the first oil sump 16 is formed in and/or on the first transmission housing 28.

In an analogous manner, the second drive train housing 14 has a second motor housing 29 for accommodating the second electric machine 10 and a second transmission housing 30 for accommodating the second transmission arrangement 12, wherein the second oil sump 18 is formed in and/or on the second transmission housing 30, as can be seen in FIG. 4.

FIG. 3 also shows that the first electric machine 5 has a first control unit 31 for supplying current to the first electric machine 5 and the second electric machine 10—which is shown in FIG. 4—has a second control unit 32 for supplying current to the second electric machine 10, wherein the first control unit 31 and the second control unit 32 are substantially identically constructed.

The terms “radial,” “axial,” “tangential” and “circumferential direction” used in this application always refer to the axis of rotation of the corresponding electric machine. The terms “left,” “right,” “above,” “below,” “over,” and “under” are used here only to clarify which areas of the illustrations are currently being described in the text. The later embodiment of the disclosure may also be arranged differently. The disclosure is further not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Drive system
2 Motor vehicle
3 First vehicle axle
4 First axle drive train
5 First electric machine
6 Unit
7 First transmission arrangement
8 Second vehicle axle
9 Second axle drive train
10 Second electric machine
11 Unit
12 Second transmission arrangement
13 First drive train housing
14 Second drive train housing
15 First oil
16 First oil sump
17 Second oil
18 Second oil sump
19 Second oil pump
20 First transmission compartment
21 First oil outlet opening
22 Second transmission compartment
23 Second oil outlet opening
24 Second gear wheel
25 First housing section
26 Second housing section
27 First motor housing
28 First transmission housing
29 Second motor housing
30 Second transmission housing
31 First control unit
32 Second control unit
33 First oil pump
34 First gear wheel
35 Second oil discharge opening
36 First oil discharge opening

1. A drive system for a motor vehicle, comprising:
a first axle drive train which drives a first vehicle axle and is accommodated in a first drive train housing,
a first electric machine and a first transmission arrangement forming a first structural unit with the first electric machine,
a second axle drive train which drives a second vehicle axle and is accommodated in a second drive train housing, and
a second electric machine and a second transmission arrangement forming a second structural unit with the second electric machine,
wherein the first electric machine and the second electric machine as well as the first transmission arrangement and the second transmission arrangement are substantially identically constructed,
wherein the first axle drive train and the second axle drive train are arranged in the drive system in a manner rotated by an angle of 10-90° with respect to one another in relation to the axes of rotation of the respective electric machines, and the first drive train housing defines a first oil sump storing a first oil, and the second drive train housing defines a second oil sump storing a second oil, and
wherein a holding volume of the first oil sump corresponds to between 0.75-1.25 of a holding volume of the second oil sump.

2. The drive system according to claim 1, further comprising at least one of:
a first oil pump is arranged in the first oil sump, which pumps the first oil from the first oil sump to the first electric machine and/or to the first transmission arrangement, and
a second oil pump is arranged in the second oil sump, which pumps the second oil from the second oil sump to the second electric machine and/or to the second transmission arrangement.

3. The drive system according to claim 1, wherein at least one of:
the first drive train housing defines a first transmission compartment for accommodating the first transmission arrangement, from which the first oil can be conveyed into the first oil sump via a first oil outlet opening, and
the second drive train housing defines a second transmission compartment for accommodating the second transmission arrangement, from which the second oil can be conveyed into the second oil sump via a second oil outlet opening.

4. The drive system according to claim 3, wherein at least one of:
the first transmission arrangement has a first gear wheel which is rotatable axially parallel to the axis of rotation of the first electric machine and by means of which the first oil located in the first transmission compartment can be conveyed out of the first transmission compartment through the first oil outlet opening into the first oil sump, and
the second transmission arrangement has a second gear wheel which is rotatable axially parallel to the axis of rotation of the second electric machine and by means of which the second oil located in the second transmission compartment can be conveyed out of the second transmission compartment through the second oil outlet opening into the second oil sump.

5. The drive system according to claim 4, wherein at least one of:
the first gear wheel has a first axis of rotation which is arranged above the first oil outlet opening in a direction of gravity, and
the second gear wheel has a second axis of rotation which is arranged above the second oil outlet opening in the direction of gravity.

6. The drive system according to claim 4, wherein at least one of:
the first gear wheel is surrounded in the a circumferential direction and in sections by a channel-like circular-ring-section-shaped first housing section of the first drive train housing, and
the second gear wheel is surrounded in the circumferential direction and in sections by a channel-like circular-ring-section-shaped second housing section of the second drive train housing.

7. The drive system according to claim 1, wherein at least one of:
the first drive train housing is of a multi-part design, and
the second drive train housing is of a multi-part design.

8. The drive system according to claim 1, wherein at least one of:
the first drive train housing comprises a first motor housing for accommodating the first electric machine and a first transmission housing for accommodating the first transmission arrangement, wherein the first oil sump is formed in and/or on the first transmission housing, and
the second drive train housing comprises a second motor housing for accommodating the second electric machine and a second transmission housing for accommodating the second transmission arrangement, wherein the second oil sump is formed in and/or on the second transmission housing.

9. The drive system according to claim 1, wherein:
the first electric machine has a first control unit for supplying current to the first electric machine and the second electric machine has a second control unit for supplying current to the second electric machine, wherein the first control unit and the second control unit are substantially identically constructed.

10. The drive system according to claim 1, wherein at least one of:
the first axle drive train comprises two first electric machines arranged coaxially to one another, axially directly adjacent to one another, each in an axial flux configuration, and
the second axle drive train comprises two second electric machines arranged coaxially to one another, axially directly adjacent to one another, each in an axial flux configuration.
